(19) United States
(12) Patent Application Publication
(10) Pub. No.: US 2021/0182881 A1
(43) Pub. Date: Jun. 17, 2021

(54) AUTOMATED CONFOUNDED AUDIENCE RESOLUTION SYSTEM

(71) Applicant: Fifth Third Bank, Cincinnati, OH (US)

(72) Inventors: Timothy N. SPENCE, Hyde Park, OH (US); Benjamin HOFFMAN, Indian Hills, OH (US); Arthur E. WESTON, Union, KY (US); Nicholas CORRIE, Cincinnati, OH (US); Christopher BECKER, Cincinnati, OH (US)

(21) Appl. No.: 17/123,351

(22) Filed: Dec. 16, 2020

Related U.S. Application Data
(60) Provisional application No. 62/949,042, filed on Dec. 17, 2019.

(51) Int. Cl. G06Q 30/02; G06Q 40/02; G06K 9/62

(52) U.S. Cl. CPC G06Q 30/0201; G06K 9/6227; G06Q 40/02; G06Q 30/0204

(57) ABSTRACT

Methods and systems are described to automatically identify, measure, and resolve the problem of confounding audiences for predictive modeling exercises involving classification. An example system is described for recursively executing an algorithm that ingests, at minimum, one or more predictors, an outcome variable, a performance improvement threshold at which the system will terminate, and a maximum recursion depth at which the system will terminate if the performance improvement threshold is not met.

### CROSS REFERENCE TO RELATED APPLICATIONS

This application claims the benefit of U.S. Provisional Patent App. No. 62/949,042, filed Dec. 17, 2019, the disclosure of which is hereby incorporated by reference herein.

### TECHNICAL FIELD

This application generally relates to predictive modeling, and more particularly relates to predictive modeling including a recursively executing an algorithm that ingests one or more predictors, an outcome variable, and a performance improvement threshold to improve prediction performance.

### BACKGROUND

In predictive modeling, the performance of an algorithm is a function of its ability to differentiate between multiple audiences by learning the statistical relationships between predictors and an outcome variable in accordance with a given objective function. Standard approaches to addressing confounded models seek to incorporate new information explaining the difference between the distinct audiences. Traditionally, this may be accomplished by adding new predictors. However, it is often difficult to determine which predictors to add a priori. Even if identified and incorporated, there is no guarantee the algorithms selected will leverage the new predictors in appropriate ways to address the problem. Improvements to predictive modeling and, more generally, to machine learning, are desirable.

### SUMMARY

Methods and systems are described to automatically identify, measure, and resolve the problem of confounding audiences for predictive modeling exercises involving classification. An example system is described for recursively executing an algorithm that ingests, at minimum, one or more predictors, an outcome variable, a performance improvement threshold at which the system will terminate, and a maximum recursion depth at which the system will terminate if the performance improvement threshold is not met.

An example method may include the steps of accessing data that identifies a plurality of members, generating, based on a first characteristic of the plurality of members, a first model that predicts a likelihood that the plurality of members is part of a first category of members, determining that a confidence measure of the first model is below a threshold, generating, based on a second characteristic of the plurality of members, at least a second model that predicts the likelihood that the one or more members is part of the first category of members, determining that the confidence measure of the second model is above the threshold, generating, based on the first characteristic of the plurality of members, a third model that predicts a likelihood that one or more of the members is part of a second category of members, determining that a confidence measure of the third model is above a threshold, generating a fourth model that is based on the second model and the third model, and generating an output that is representative of the fourth model.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1A shows an example confounded model based on household income;

FIG. 1B shows an example confounded model based on education level;

FIG. 1C shows an example confounded model based on month of purchase;

FIG. 2A shows an example model of opposing event audiences for purchasing a low balance checking account based on household income;

FIG. 2B shows an example model of opposing event audiences for purchasing a low balance checking account based on education level;

FIG. 2C shows an example model of opposing event audiences for purchasing a low balance checking account based on month of purchase;

FIG. 2D shows an example model of opposing event audiences for purchasing a high balance checking account based on household income;

FIG. 2E shows an example model of opposing event audiences for purchasing a high balance checking account based on education level;

FIG. 2F shows an example model of opposing event audiences for purchasing a high balance checking account based on month of purchase;

FIG. 3 shows an example method in accordance with an aspect of the disclosure;

FIG. 4A shows an example chart for building an initial model;

FIG. 4B shows an example chart depicting a subset of the population;

FIG. 4C shows an example chart for scoring the population and identifying an optimal segmenting of the population;

FIG. 4D shows an example chart for building a model based on the segmented predictors;

FIG. 4E shows an example chart for comparing combined scores to determine an improvement in the model;

FIG. 5A shows an example model for separating an audience using a conditional balance for purchasing a low balance checking account based on household income;

FIG. 5B shows an example model for separating an audience using a conditional balance for purchasing a low balance checking account based on education level;

FIG. 5C shows an example model for separating an audience using a conditional balance for purchasing a low balance checking account based on month of purchase;

FIG. 5D shows an example model for separating an audience using a conditional balance for purchasing a high balance checking account based on household income;

FIG. 5E shows an example model for separating an audience using a conditional balance for purchasing a high balance checking account based on education level;

FIG. 5F shows an example model for separating an audience using a conditional balance for purchasing a high balance checking account based on month of purchase;

FIG. 6 shows an example method in accordance with an aspect of the disclosure;

FIG. 7A shows an example model for separating an audience using a best available proxy for purchasing a low balance checking account based on household income;

FIG. 7B shows an example model for separating an audience using a best available proxy for purchasing a low balance checking account based on education level;

FIG. 7C shows an example model for separating an audience using a best available proxy for purchasing a low balance checking account based on month of purchase;

FIG. 7D shows an example model for separating an audience using a best available proxy for purchasing a high balance checking account based on household income;

FIG. 7E shows an example model for separating an audience using a best available proxy for purchasing a low balance checking account based on education level;

FIG. 7F shows an example model for separating an audience using a best available proxy for purchasing a low balance checking account based on month of purchase;

FIG. 8A shows performance results of the confounded model;

FIG. 8B shows performance improvements of the model using the method described in FIG. 3;

FIG. 8C shows performance improvements of the model using the method described in FIG. 6; and

FIG. 9 shows a block diagram of an example computing device.

### DETAILED DESCRIPTION OF ILLUSTRATIVE EMBODIMENTS

Machine learning, a type of artificial intelligence that “learns” as it identifies new patterns in data, enables data scientists to effectively pinpoint revenue opportunities and create strategies to improve customer experiences using information hidden in huge data sets. Selecting the right algorithm is a key part of any machine learning project, and because there are dozens to choose from, understanding their strengths and weaknesses in various business applications is essential.

In random forest machine learning algorithms, decision trees use directed graphs to model decision making. Each node on the graph represents a question about the data and the branches stemming from each node represent the possible answers to that question. Compounding hundreds or even thousands of these decision trees is an “ensemble” method called a random forest. Though highly accurate, random forests are often dubbed black box models because they are complex to the point that they can be difficult to interpret. For example, understanding how a random forest model approves or denies a loan could involve sifting through thousands of finely-tuned decisions. Nevertheless, random forest models are popular due to their high accuracy and relatively low computational expense. They are used for a wide variety of applications including churn modeling and customer segmentation.

The goal of artificial neural network machine learning algorithms is to mimic the way the human brain organizes and understands information in order to arrive at various predictions. In artificial neural networks, information is passed through an input layer, a hidden layer, and an output layer. The input and output layers may include raw features and predictions, respectively. The hidden layer in between consists of many highly interconnected neurons capable of complex meta-feature engineering. As the neural network “learns” the data, the connections between these neurons are fine-tuned until the network yields highly accurate predictions. This biological approach to computation allows neural networks to excel at some of the most challenging, high-dimensional problems in artificial intelligence, such as speech and object recognition, image segmentation, and natural language processing. Like random forests, neural networks are difficult, if not impossible, to interpret without the use of additional tools such as an open source model interpretation package. This means that data scientists will often defer to simpler machine learning algorithms unless their analysis demands superior accuracy.

Logistic regression, which is borrowed from the field of classical statistics, is one of the simpler machine learning algorithms. This machine learning technique is commonly used for binary classification problems, meaning those in which there are two possible outcomes that are influenced by one or more explanatory variables. The algorithm estimates the probability of an outcome given a set of observed variables. Where logistic regression differs from other methods is in its interpretability. Since this algorithm is derived from the highly interpretable linear regression algorithm, the influence of each data feature can be interpreted without much effort. As a result, logistic regression is often favored when interpretability and inference is paramount. This versatile algorithm is used to determine the outcome of binary events such as customer churn, marketing click-throughs, or fraud detection.

Kernel methods are a group of machine learning algorithms used for pattern analysis, which involves organizing raw data into rankings, clusters, or classifications. These methods allow data scientists to apply their domain knowledge of a given problem by building custom kernels that incorporate the data transformations that are most likely to improve the accuracy of the overall mode. The most popular application of kernels is the support vector machine (SVM), which builds a model that classifies new data as belonging to one category or another based on a set of training examples. A SVM makes these determinations by representing each example as a point in a multi-dimensional space called a hyperplane. The points are then separated into categories by maximizing the distance (called a “margin”) between the different apparent groups in the data. Kernel methods are useful if you have domain knowledge pertaining to the decision boundaries beforehand, which usually isn't the case except for the most common problems. As a result, practitioners usually opt for a more “out-of-the-box” machine learning algorithm.

Clustering is a type of unsupervised learning, which is used when working with data that does not have defined categories or groups (unlabeled data). The goal of k-means clustering is to find distinct groups in the data based on inherent similarities between them rather than predetermined labels. K represents the total number of unique groups the algorithm will create. Each example is assigned to one group or another based on similarity to other examples across a set of characteristics called features. K-means clustering is useful for business applications like customer segmentation, inventory categorization, and anomaly detection.

Ultimately, the best machine learning algorithm to use for any given project depends on the data available, how the results will be used, and the data scientist's domain expertise on the subject. Understanding how they differ is a key step to ensuring that every predictive model your data scientists build and deploy delivers valuable results.

In predictive modeling, the performance of an algorithm is a function of its ability to differentiate between multiple audiences by learning the statistical relationships between predictors and an outcome variable in accordance with a given objective function. Using retail as an industry example, it is often desirable to build predictive models that estimate a consumer's likelihood to purchase a given product. When building such models, many distinct audiences may be present beyond those explicitly defined. For example, consumers who purchased a product may be assigned a value of one while all others are assigned a value of zero; yet consumers who are assigned ones may have purchased the product for different reasons. When this occurs, a model is said to be confounded. To the extent that the distinct event audiences exhibit opposing relationships with available predictors, the model's performance can suffer considerably.

Standard approaches to addressing confounded models seek to incorporate new information explaining the difference between the distinct audiences. Traditionally, this is accomplished by adding new predictors. However, it is often difficult, or impossible, to determine which predictors to add a priori. Even if identified and incorporated, there is no guarantee the algorithms selected will leverage the new predictors in appropriate ways to address the problem. An alternative solution, such as that described herein, would seek to automatically identify sub-audiences that display confounding tendencies and to use that information to alter the outcome variable to remove any detrimental biases.

Methods and systems are described to automatically identify, measure, and resolve the problem of confounding audiences for predictive modeling exercises involving classification. At the highest level, a system is described for recursively executing an algorithm that ingests, at minimum, one or more predictors, an outcome variable, a performance improvement threshold at which the system will terminate, and a maximum recursion depth at which the system will terminate if the performance improvement threshold is not met.

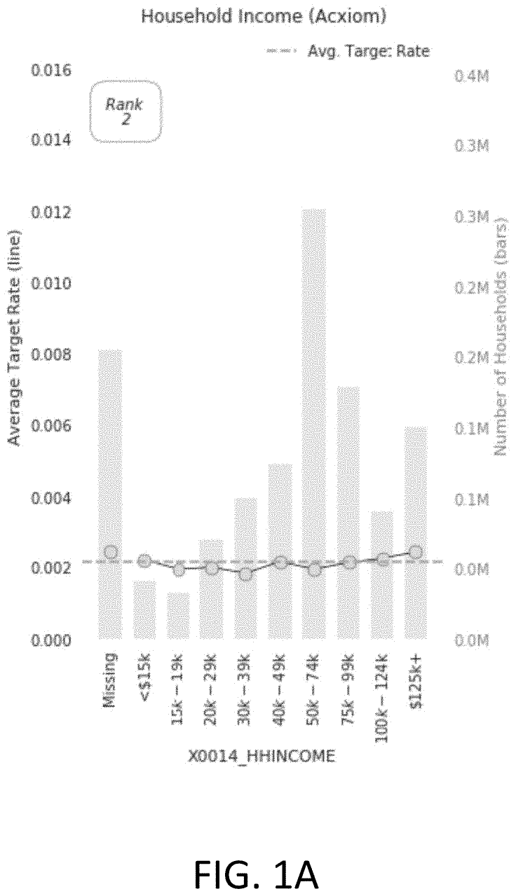

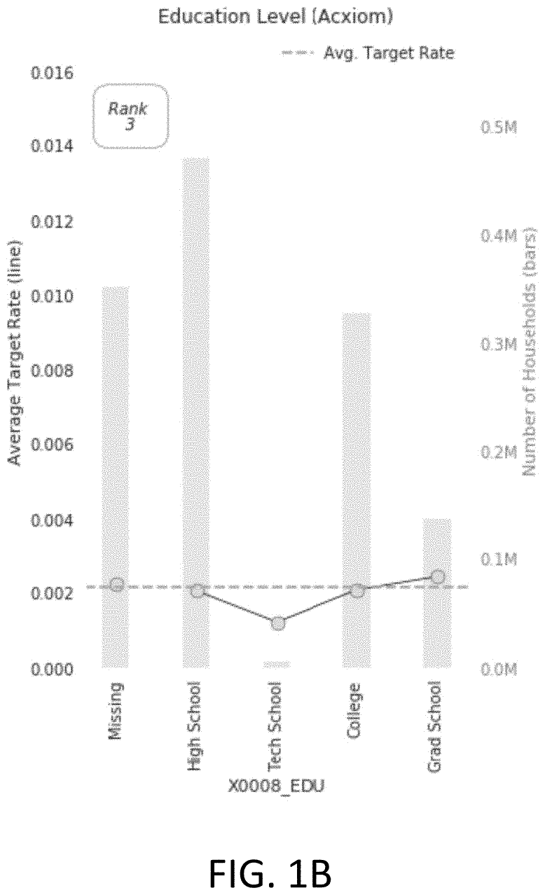

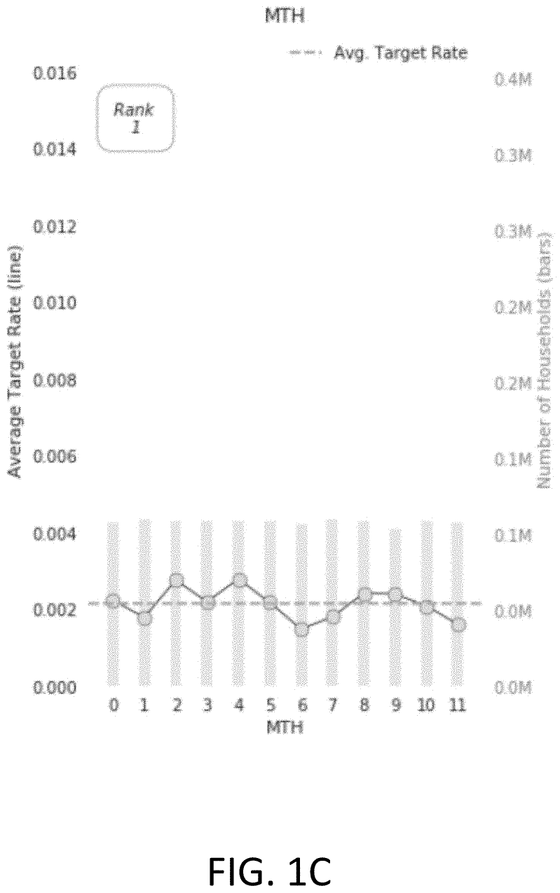

Consider an example of a retail bank that offers two checking products: one for underbanked consumers and another for affluent consumers. If the bank were to build a predictive model in an attempt to identify which consumers are most likely to purchase one of their checking products, where the only predictors were the income associated with each consumer, their education level, and their month of purchase, the model would struggle to perform better than random chance. This is because two distinct event audiences are being combined whose relationships with income and education are in direct opposition, thus canceling out and eliminating each predictor's power. FIGS. 1A-1C show an example of a model when two opposing event audiences are combined. As shown in the figure, the predictive power of the model fails to perform much better, if at all, than random chance.

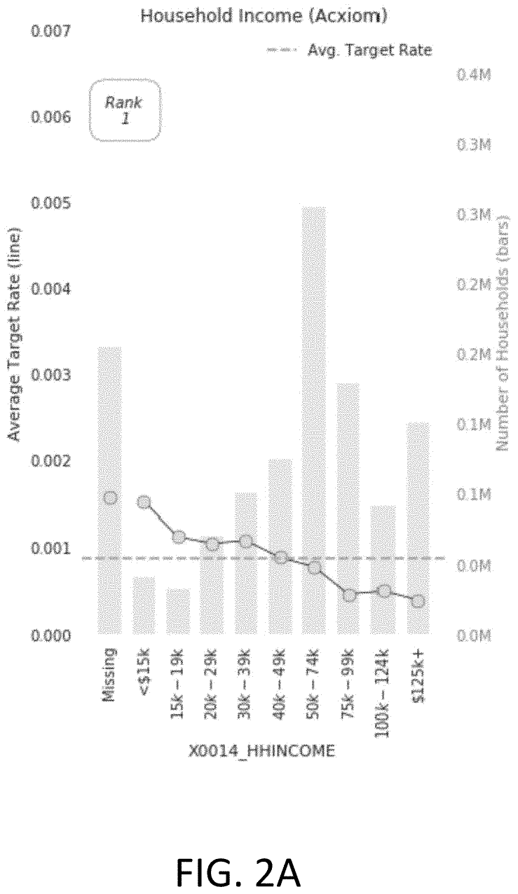

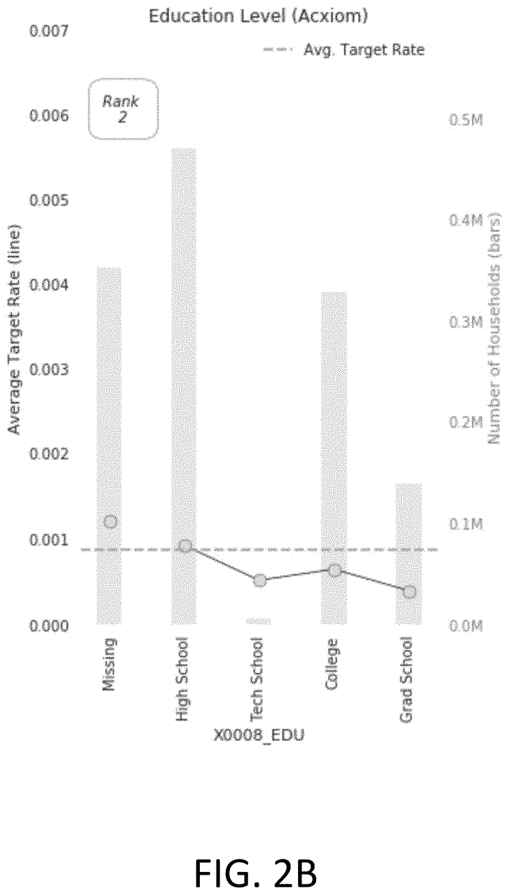

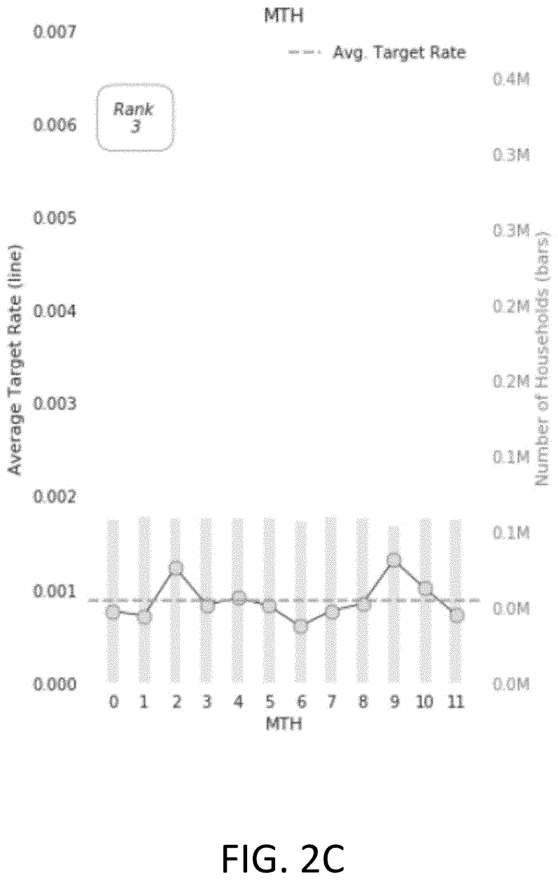

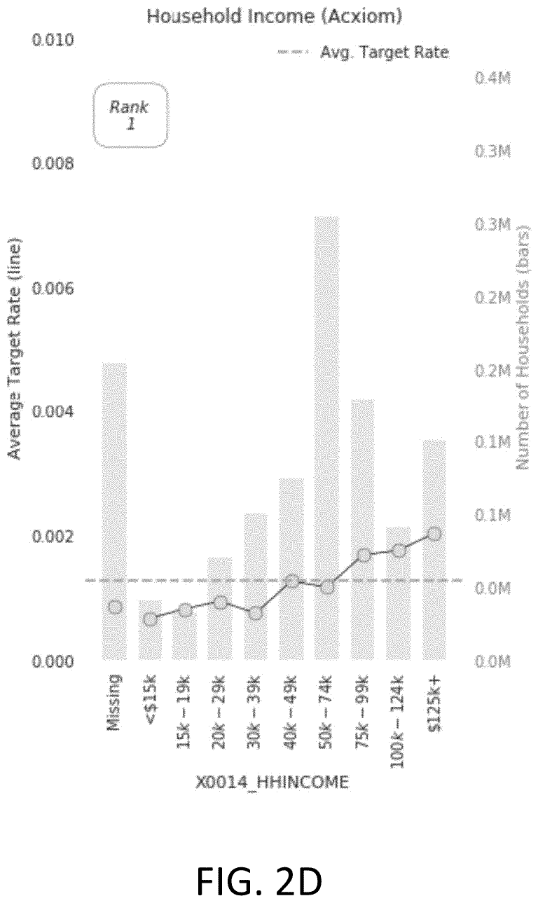

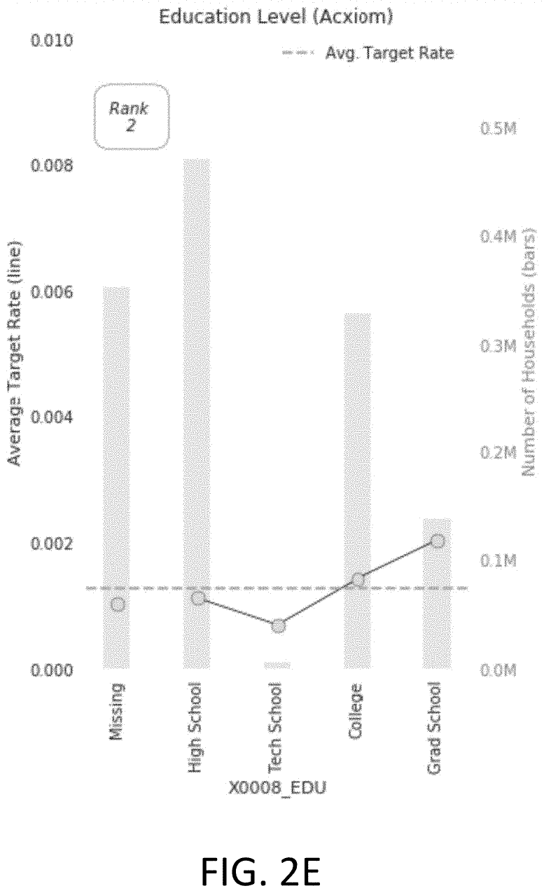

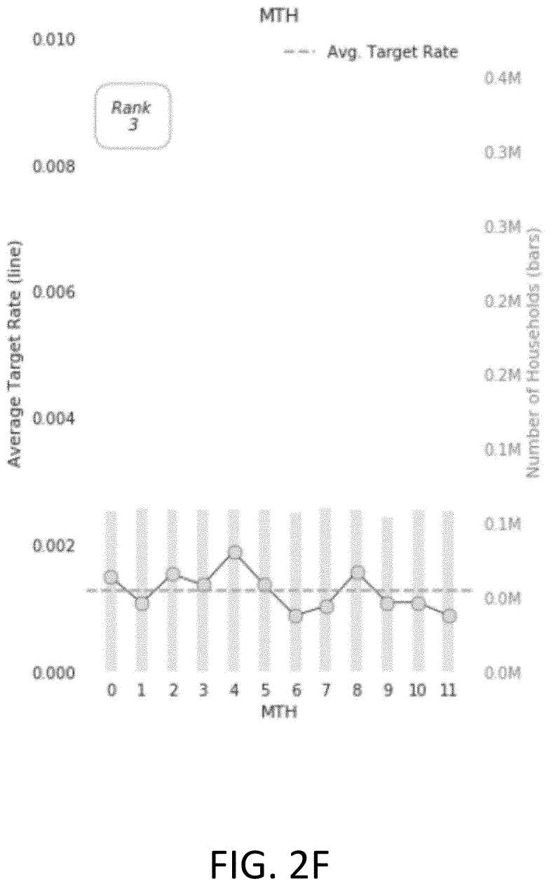

One example solution to this problem would be to separate the distinct event audiences such that the bank would build two models: one predicting those most likely to acquire the underbanked product and another predicting those most likely to acquire the affluent product. An example of such models is shown in FIGS. 2A-2F. However, for an analyst who is unaware of the fact that two audiences have been combined, the question remains how they would address the model's poor performance.

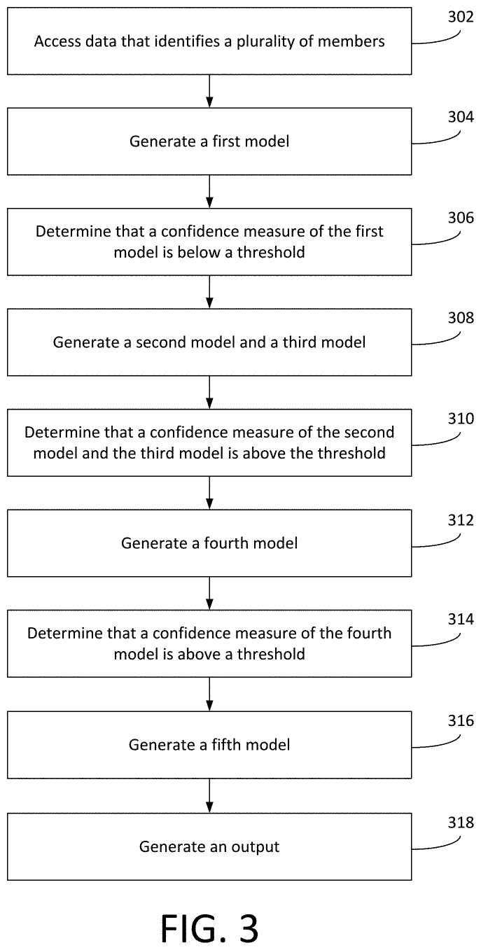

FIG. 3 shows a flow chart of an example method 300 for predictive modeling. The method 300 is described in the context of an example for purchasing a checking account. However, it is understood that the method 300 is not limited to this example and may be applied to any type of predictive modeling or machine learning.

At step 302, data may be accessed. The data may identify a plurality of members. The plurality of members may include a plurality of members of a population. The plurality of members of the population may include a plurality of members of a population who have opened a checking account with a bank.

At step 304, a first model may be generated. The first model may be based on a first characteristic of the plurality of members. The first characteristic of the plurality of members may include an income level of the plurality of members. The first characteristic of the plurality of members may include an education level of the plurality of members. The first characteristic of the plurality of members may include a month that a checking account was purchased by the plurality of members. The first characteristic of the plurality of members may include an initial account balance of the plurality of members. The first model may predict the likelihood that the plurality of members is part of a first category of members. The first category of members may include one or more members of a population that perform a first action. The first category of members may include one or more members of a population that purchase a first product. The first product may be a first type of checking account, such as a free checking account or a low balance checking account.

At step 306, it may be determined that a confidence measure of the first model is below a threshold. The confidence measure may be indicative of a predictive performance of the first model. It may be determined that the first model is able to predict the likelihood of an event occurring with a 60% accuracy. However, the desired (e.g., threshold) predictive performance of the first model may be 75%. Using the example above, the first model may be able to predict a likelihood that an individual will purchase the first type of checking account (e.g., a free checking account) with an accuracy of 60%. However, the model is underperforming as the threshold predictive performance for the model is 75%.

At step 308, a second model may be generated. The second model may be generated based on the determination that the confidence measure of the first model is below the threshold. The second model may be based on a second characteristic of the plurality of members. The second model may predict the likelihood that the one or more members is part of the first category of members. The second model may consider one or more other characteristics of the plurality of members than those that were considered in the first model. For example, if the first model is based on an income of the plurality of members, the second model may be based on an education level of the plurality of members.

At step 310, it may be determined that the confidence measure of at least one of the second model is above the threshold. At least one of the second model may have a confidence measure that is above the 75% threshold (e.g., 85%). By applying the education level of the plurality of members to the first model that considers the income level of the plurality of members, the second model may have an improved accuracy that is above the 75% threshold.

At step 312, a third model may be generated. The third model may be generated based on the first characteristic of the plurality of members. The third model may predict a likelihood that one or more of the members is part of a second category of members. The second category of members may include one or more members of the population that perform a second action. The second category of members may include one or more members of the population that purchase a second product. The second product may be a second type of checking account such as a premium checking account or a high balance checking account.

At step 314, it may be determined that a confidence measure of the third model is above the threshold. The third model may have a confidence measure that is above the 75% threshold. For example, the third model may be able to predict a likelihood that an individual will purchase the second type of checking account (e.g., the premium checking account) with an accuracy of 80%.

At step 316, a fourth model may be generated. The fourth model may be generated based on the second model and the third model. The fourth model may represent a recombination of the second model, the third model, and the third model such that data may be applied more easily using a single model. The fourth model may predict whether an individual is likely to perform a first action or a second action. For example, the fourth model may predict whether an individual is likely to purchase a first type of checking account or a second type of checking account.

At step 318, an output may be generated. The output may be based on the fourth model. The output may represent a graph, table, or other representation that indicates a likelihood of an individual to perform an action. For example, the output may represent the fourth model that predicts whether an individual is likely to purchase a first type of checking account or a second type of checking account.

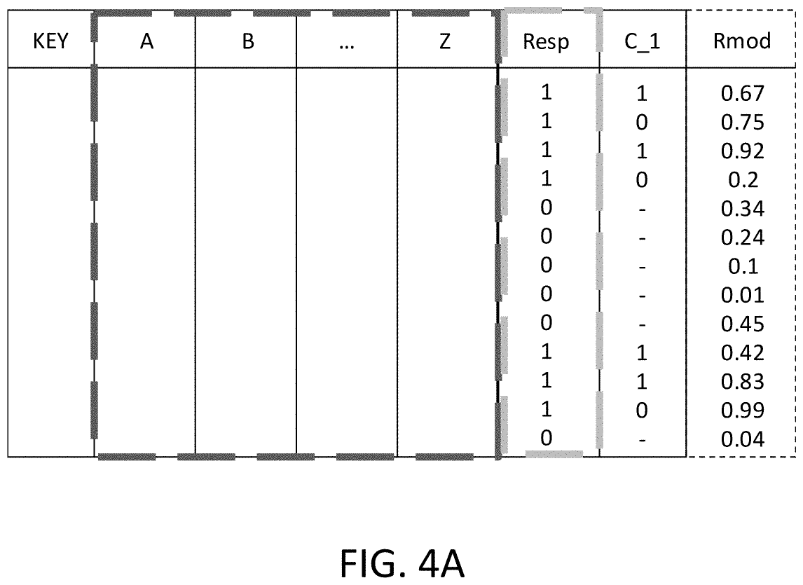

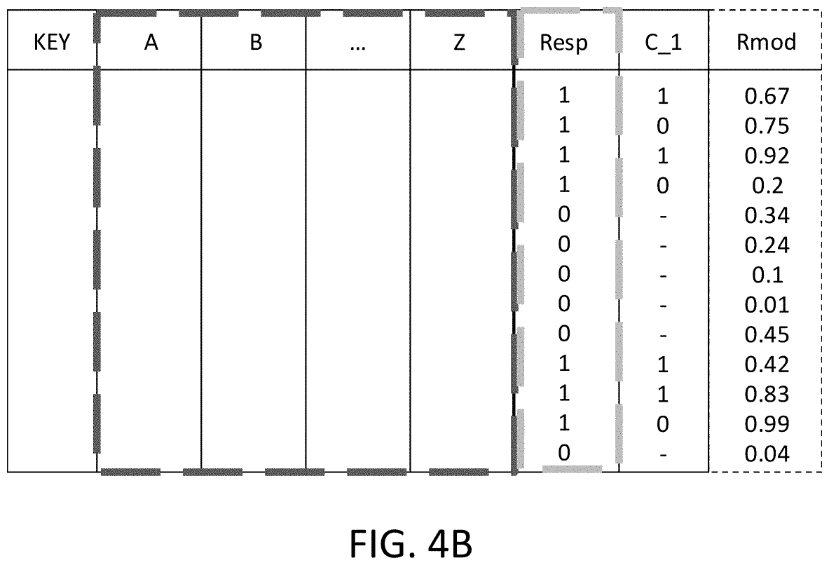

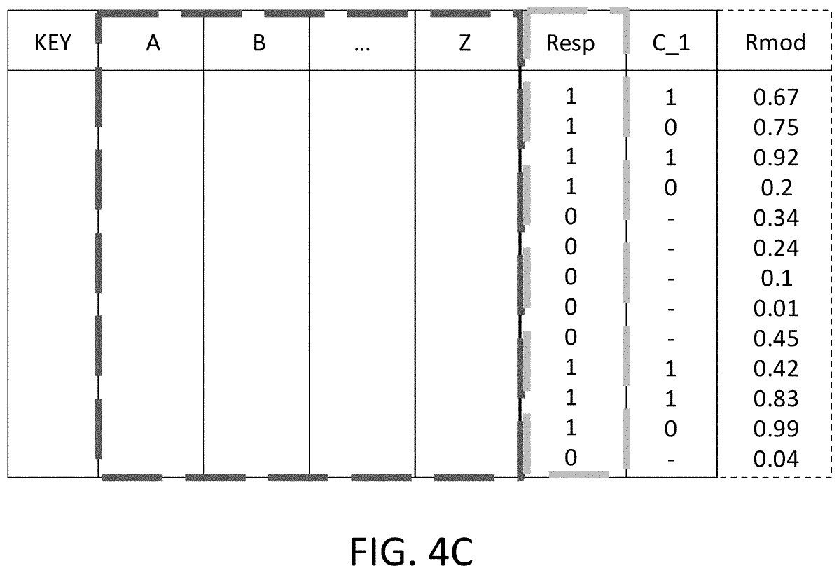

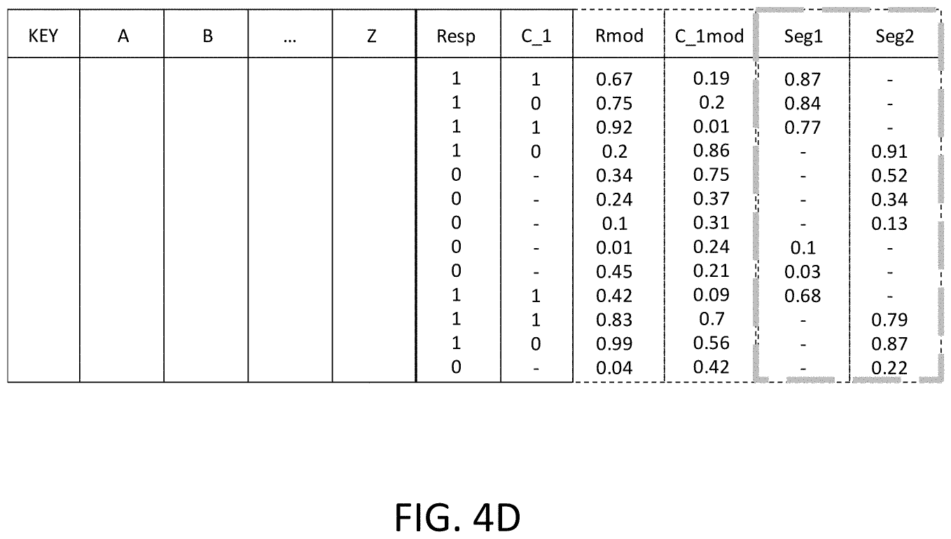

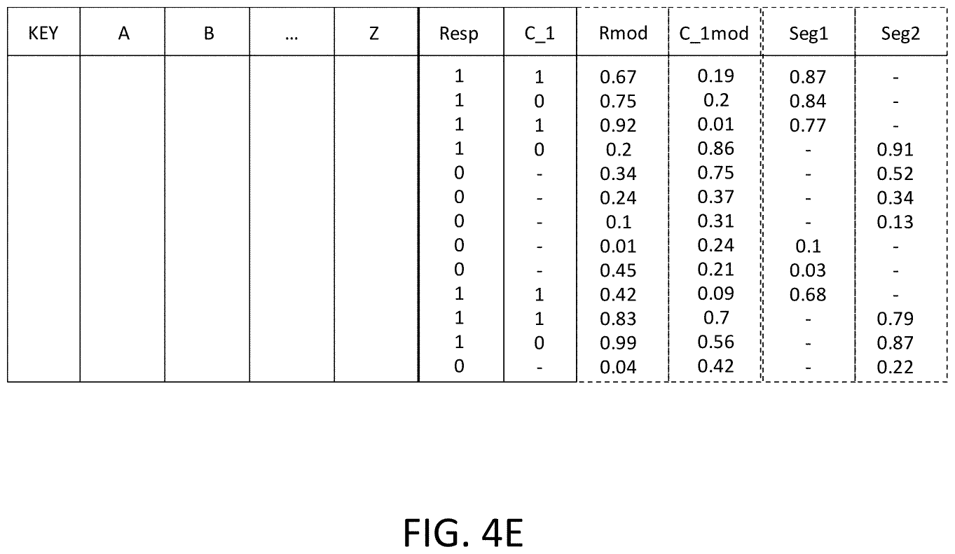

FIGS. 4A-4E show graphical improvements of the predictive performance models, such as the model discussed in connection with FIG. 3. As shown in FIG. 4A, predictors A through Z may be used to build a model predicting a response “Resp” and may store the resulting scores in “Rmod” for future comparison. In FIG. 4B, the population may be segmented to include only the population members who experienced the outcome (i.e., where “Resp” is equal to one). A subset of the predictors A through Z may be used to build the model “C_1mod” predicting “C_1” (i.e., conditional outcome one). In FIG. 4C, the entire population may be scored using “C-1mod”. The optimal cut(s) to segment the “C_1mod” may be identified, and the population may be segmented accordingly. In the example shown in FIG. 4C, two segments are produced: A (where “C_1mod” is less than 0.25) and B (where “C_1mod” is greater than or equal to 0.25). However, it is understood that any number of segments may be produced. In FIG. 4D, the segmented predictors A through Z may be used to build models predicting the segmented “Resp” and the resulting scores may be stored in “Seg1” and “Seg2”. In FIG. 4E, the combined scores from “Seg1” and “Seg2” may be combined to the original “Rmod” to assess the improvement against the original “Resp” column. If no significant improvement is observed, one or more steps of this process may be repeated using additional conditional outcomes. If all conditional outcomes are exhausted with no improvement observed, it may be concluded that, given all available information, no significant confounding exists within the outcome being predicted.

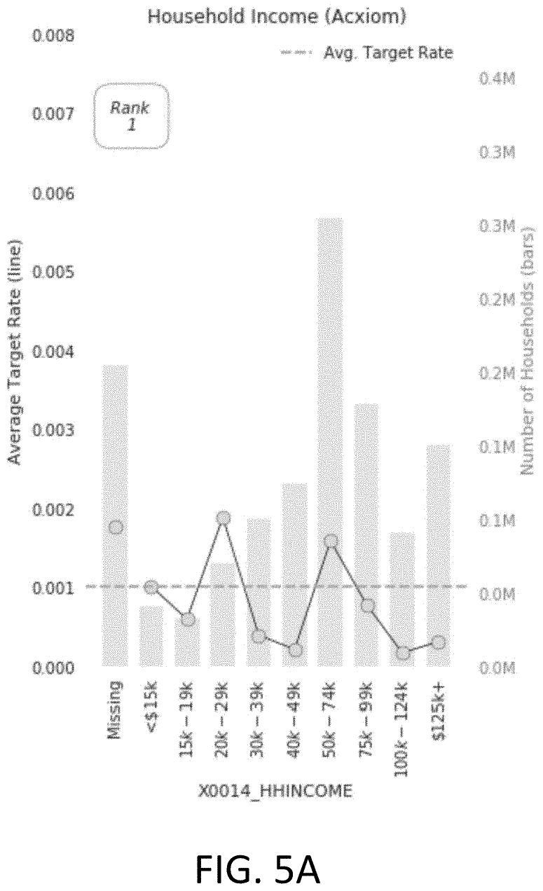

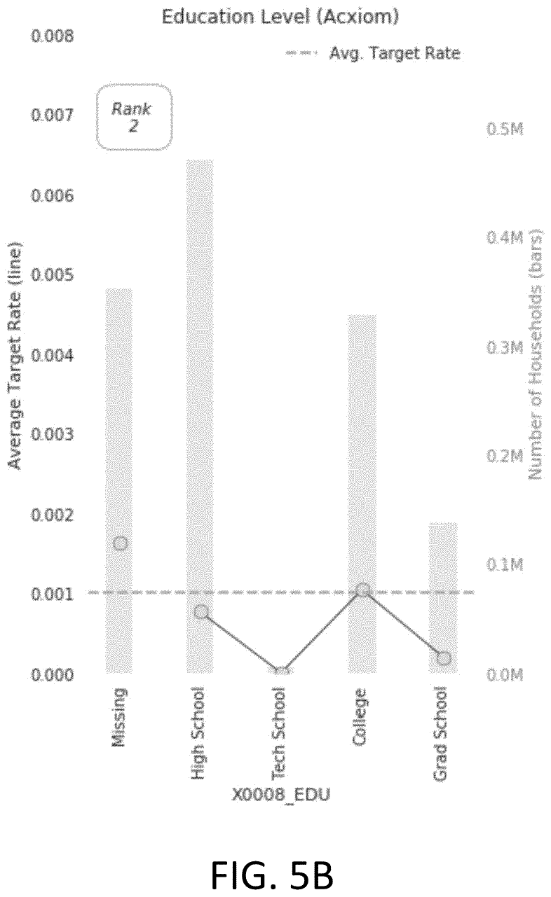

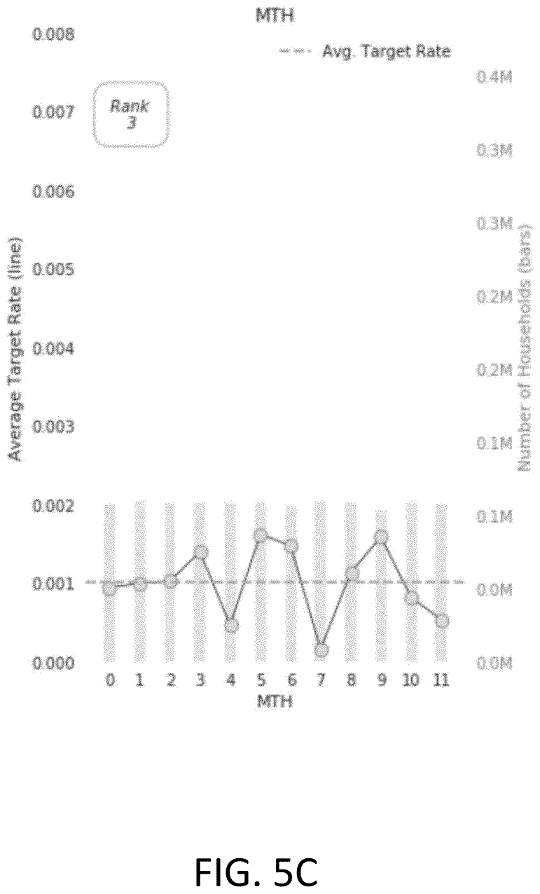

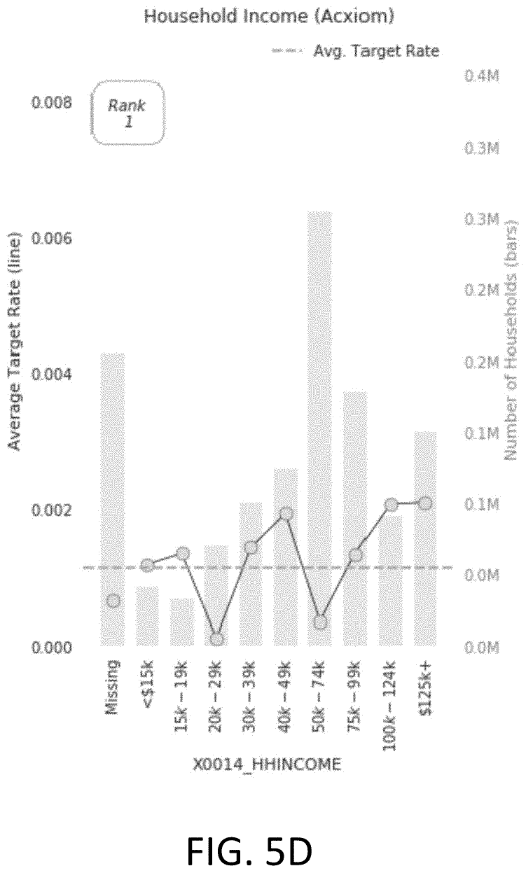

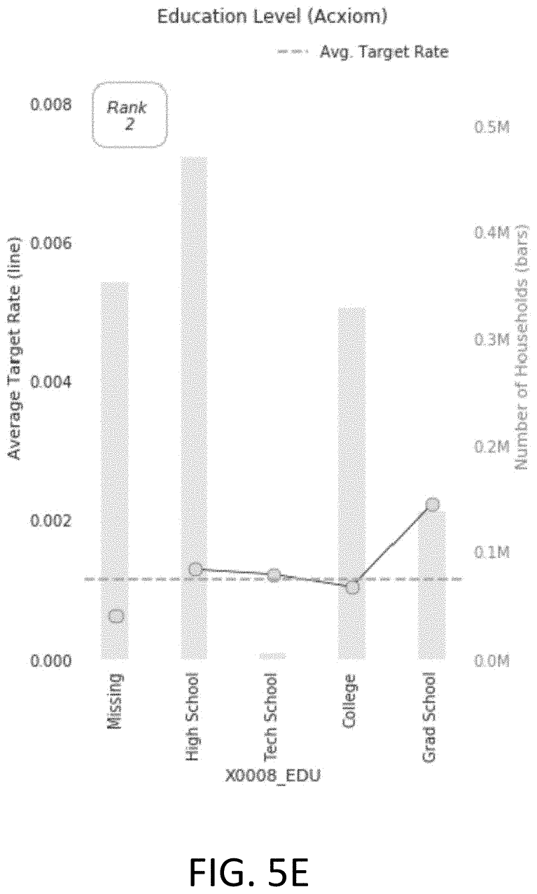

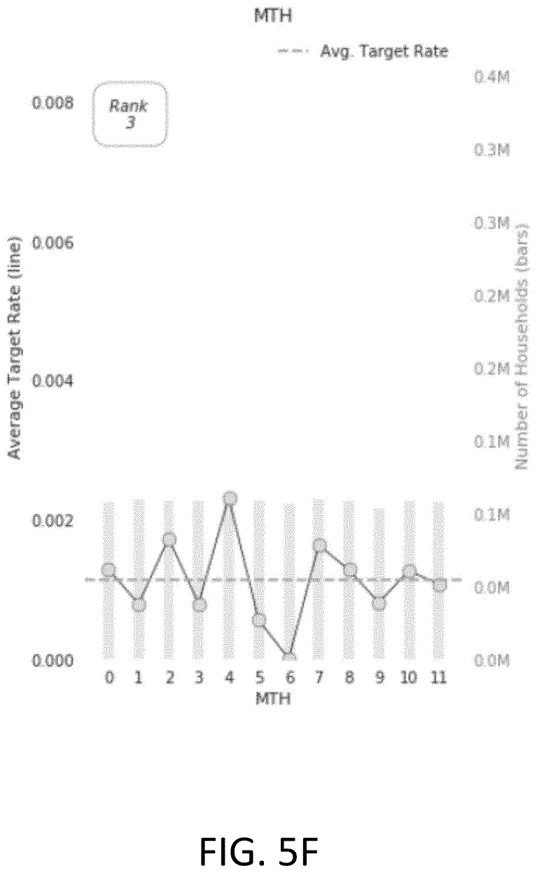

FIGS. 5A-5F show the improvement of the predictive performance of the models. For example, FIGS. 5A-5C show the predictive performance of the models in purchasing a low balance checking account based on an income, education level, and month purchased, respectively, while FIGS. 5D-5F show the predictive performance of the models in purchasing a high balance checking account based on an income, education level, and month purchased, respectively.

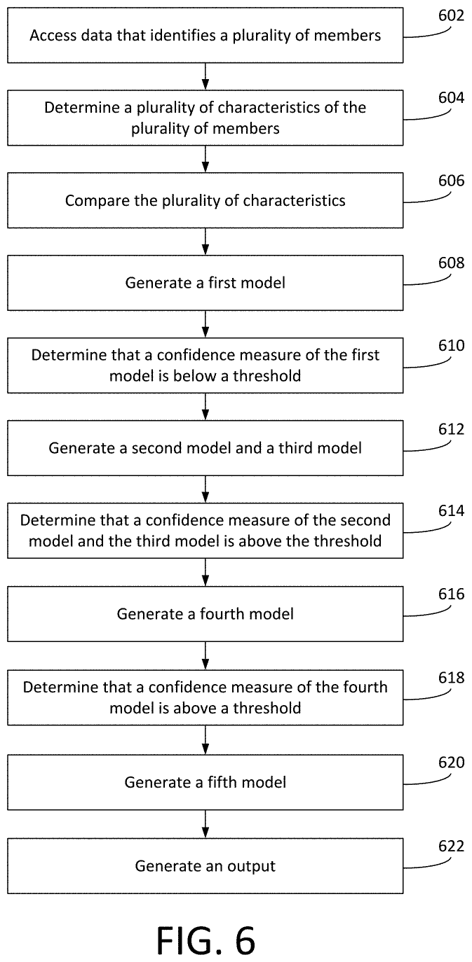

FIG. 6 shows a flow chart of an example method 600 for predictive modeling. The method 600 is described in the context of an example for purchasing a checking account. However, it is understood that the method 600 is not limited to this example and may be applied to any type of predictive modeling or machine learning.

At step 602, data may be accessed. The data may identify a plurality of members. The plurality of members may include a plurality of members of a population. The plurality of members of the population may include a plurality of members of a population who have opened a checking account with a bank.

At step 604, a plurality of characteristics associated with the plurality of members may be determined. The plurality of characteristics associated with the plurality of members may include one or more of an income level of the plurality of members, an education level of the plurality of members, a month that the checking account was purchased by the plurality of members, and an initial account balance of the plurality of members. It is understood that the above characteristics are exemplary only and that any type of characteristic may be considered.

At step 606, the plurality of characteristics may be compared to determine an impact of each of the plurality of characteristics on intra-level predictive performance. In an example, each of the characteristics may be used to predict one or more other of the characteristics. An income predictor and a month of purchase predictor may be used to estimate an education level. An education level predictor and a month of purchase predictor may be used to estimate an income level predictor. An income predictor and an education level predictor may be used to estimate a month of purchase predictor. Based on the predictions above, the predictor with the greatest intra-level predictive performance may be selected.

At step 608, a first model may be generated. The first model may be based on a first characteristic of the plurality of members. The first characteristic may be the characteristic with the greatest intra-level predictive performance. The first model may predict the likelihood that the plurality of members is part of a first category of members. The first category of members may include one or more members of a population that perform a first action. The first category of members may include one or more members of a population that purchase a first product. The first product may be a first type of checking account, such as a free checking account or a low balance checking account.

At step 610, it may be determined that a confidence measure of the first model is below a threshold. The confidence measure may be indicative of a predictive performance of the first model. It may be determined that the first model is able to predict the likelihood of an event occurring with a 60% accuracy. However, the desired (e.g., threshold) predictive performance of the first model may be 75%. Using the example above, the first model may be able to predict a likelihood that an individual will purchase the first type of checking account (e.g., a free checking account) with an accuracy of 60%. However, the model is underperforming as the threshold predictive performance for the model is 75%.

At step 612, a second model may be generated. The second model may be generated based on the determination that the confidence measure of the first model is below the threshold. The second model may be based on a second characteristic of the plurality of members. The second characteristic may be the characteristic with the second highest intra-level predictive performance. The second model may predict the likelihood that the one or more members is part of the first category of members. The second model may consider one or more other characteristics of the plurality of members than those that were considered in the first model. For example, if the first model is based on an income of the plurality of members, the second model may be based on an education level of the plurality of members.

At step 614, it may be determined that the confidence measure of at least one of the second model is above the threshold. At least one of the second model may have a confidence measure that is above the 75% threshold (e.g., 85%). By applying the education level of the plurality of members to the first model that considers the income level of the plurality of members, the second model may have an improved accuracy that is above the 75% threshold.

At step 616, a third model may be generated. The third model may be generated based on the first characteristic of the plurality of members. The third model may predict a likelihood that one or more of the members is part of a second category of members. The second category of members may include one or more members of the population that perform a second action. The second category of members may include one or more members of the population that purchase a second product. The second product may be a second type of checking account such as a premium checking account or a high balance checking account.

At step 618, it may be determined that a confidence measure of the third model is above the threshold. The third model may have a confidence measure that is above the 75% threshold. For example, the third model may be able to predict a likelihood that an individual will purchase the second type of checking account (e.g., the premium checking account) with an accuracy of 80%.

At step 620, a fourth model may be generated. The fourth model may be generated based on the second model and the third model. The fourth model may represent a recombination of the second model, the third model, and the third model such that data may be applied more easily using a single model. The fourth model may predict whether an individual is likely to perform a first action or a second action. For example, the fourth model may predict whether an individual is likely to purchase a first type of checking account or a second type of checking account.

At step 622, an output may be generated. The output may be based on the fourth model. The output may represent a graph, table, or other representation that indicates a likelihood of an individual to perform an action. For example, the output may represent the fourth model that predicts whether an individual is likely to purchase a first type of checking account or a second type of checking account.

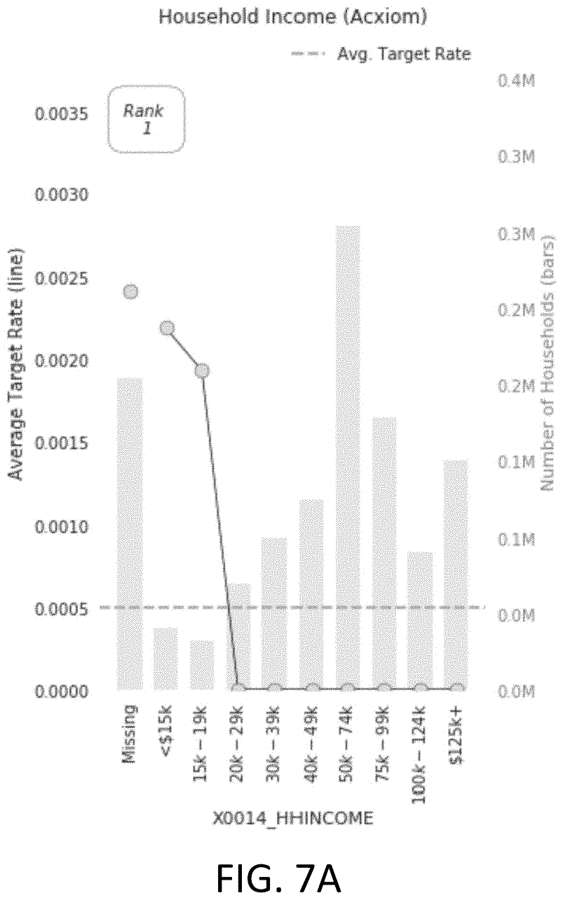

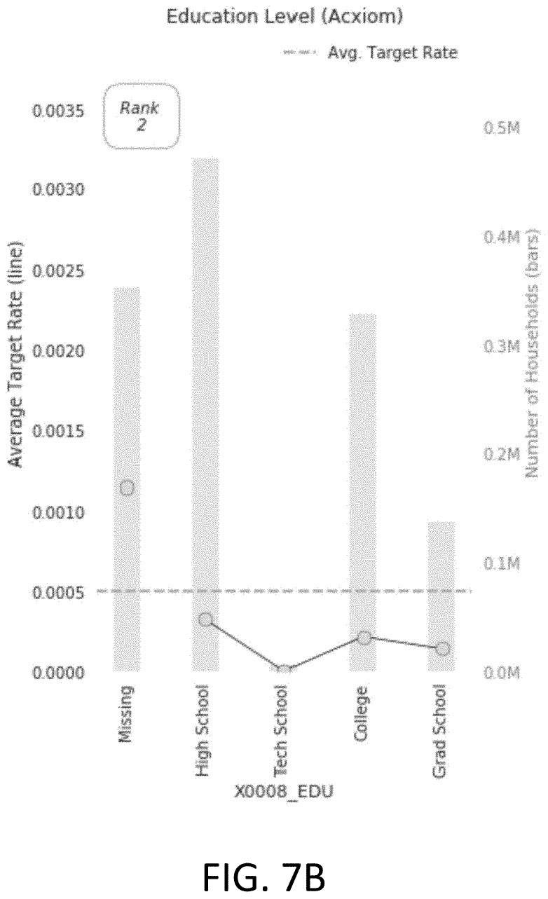

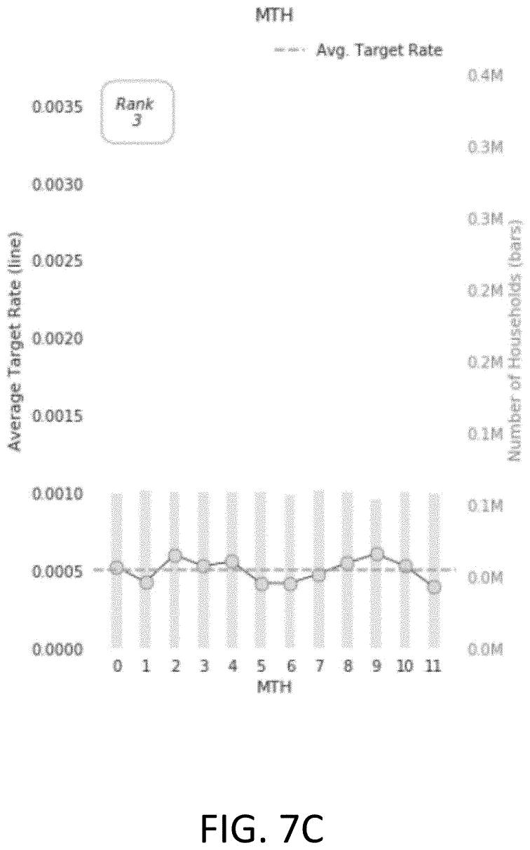

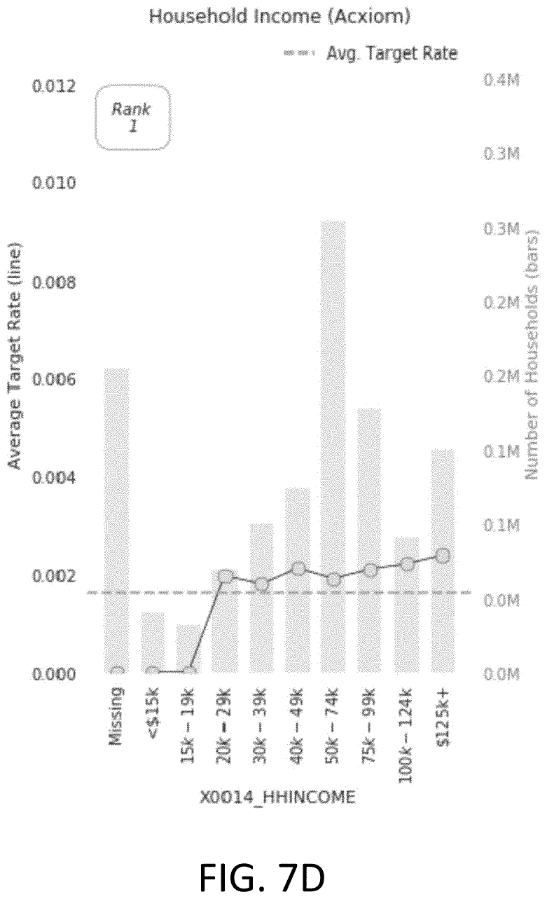

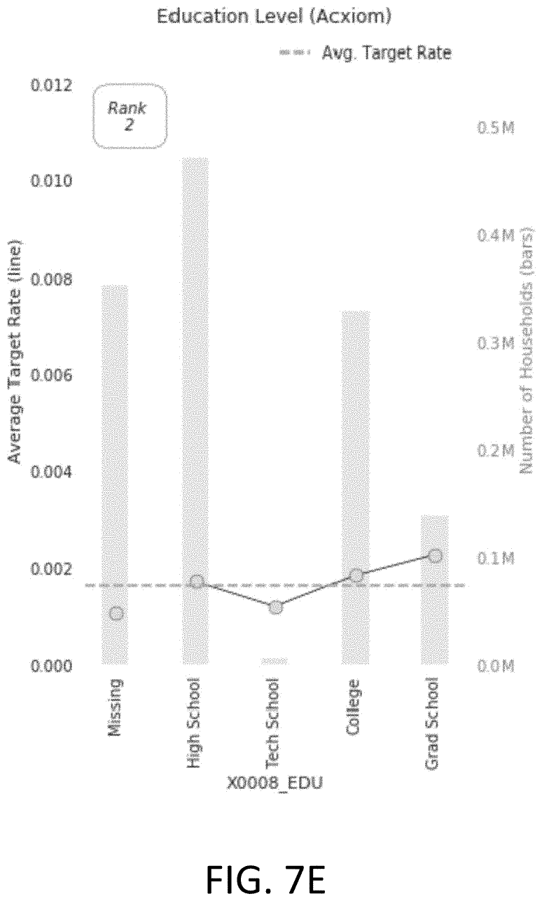

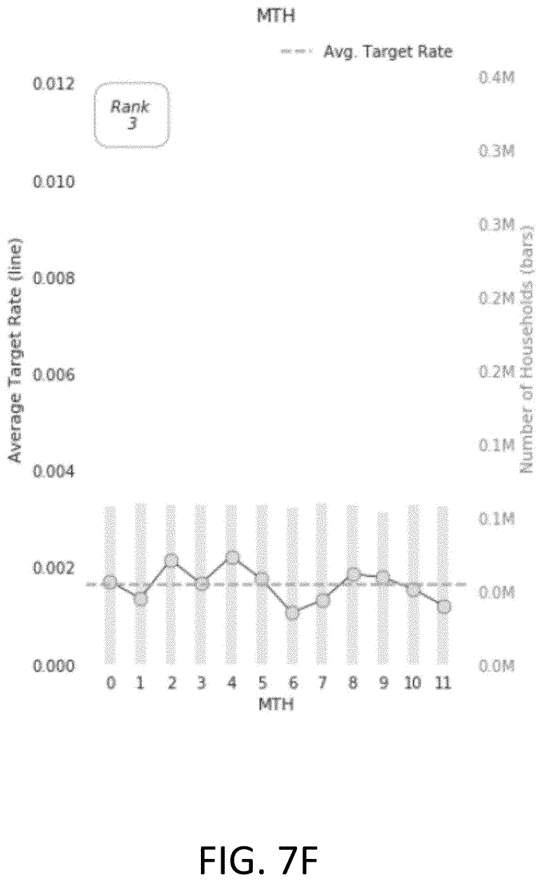

FIGS. 7A-7F show the improvement of the predictive performance of the models. For example, FIGS. 7A-7C show the predictive performance of the models in purchasing a low balance checking account based on an income, education level, and month purchased, respectively, while FIGS. 7D-7F show the predictive performance of the models in purchasing a high balance checking account based on an income, education level, and month purchased, respectively.

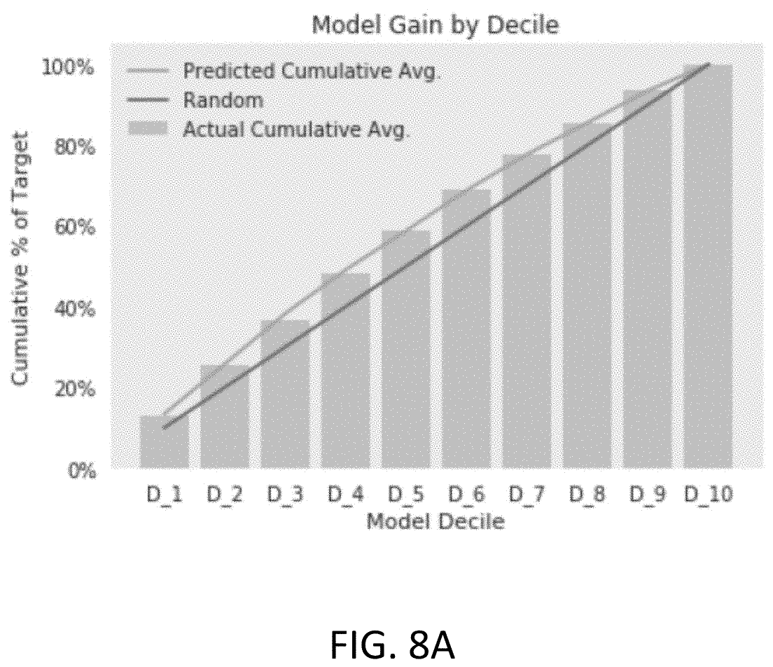

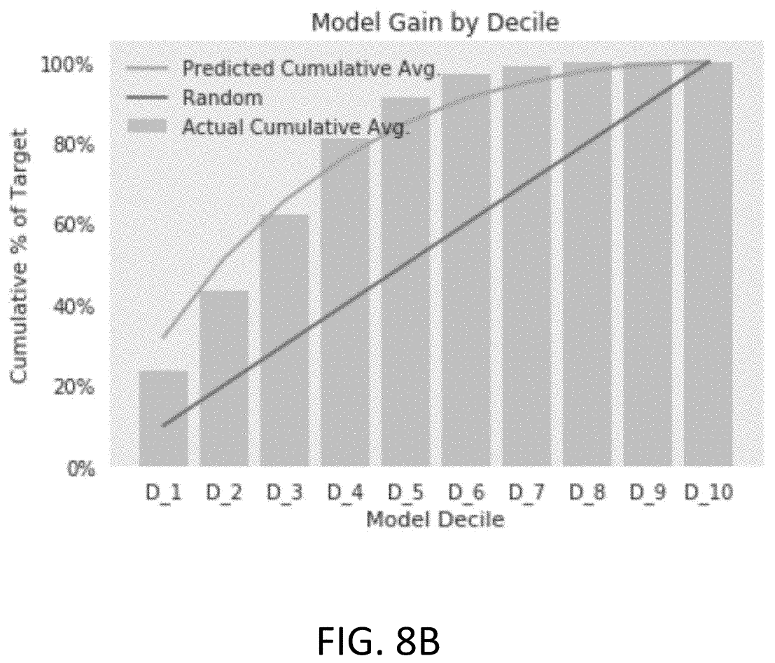

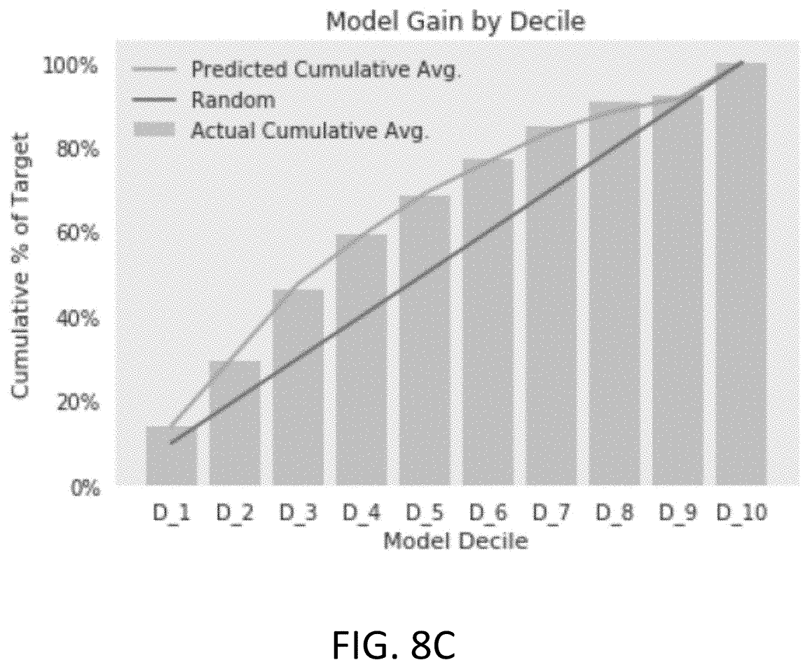

FIGS. 8A, 8B and 8C represent gain charts which can be used to summarize the system's performance improvements. As shown in FIG. 8A, the confounded model performed only slightly better than random chance across all deciles. However, application of the method applied in FIG. 3 resulted in significant lift, as shown in FIG. 8B, while the application of the method applied in FIG. 6 resulted in a moderate lift, as shown in FIG. 8C.

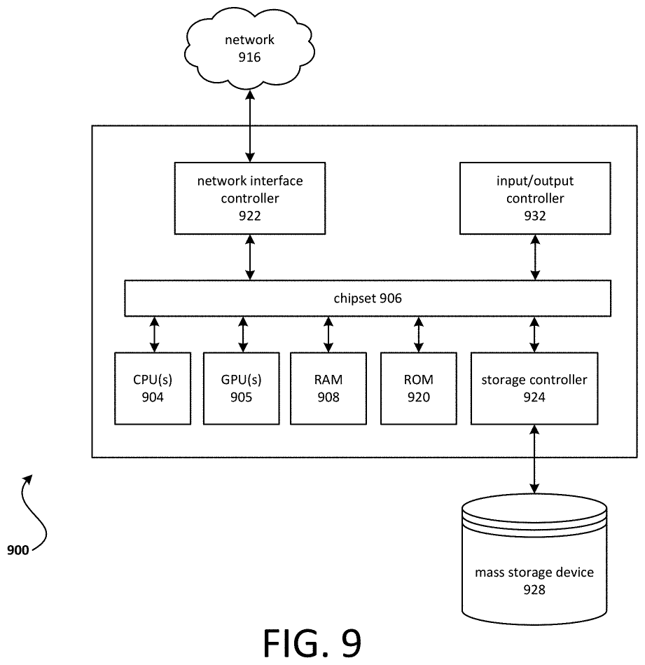

FIG. 9 depicts a computing device that may be used in various aspects. The computing device 900 may include a baseboard, or “motherboard,” which is a printed circuit board to which a multitude of components or devices may be connected by way of a system bus or other electrical communication paths. One or more central processing units (CPUs) 904 may operate in conjunction with a chipset 906. The CPU(s) 904 may be standard programmable processors that perform arithmetic and logical operations necessary for the operation of the computing device 900.

The CPU(s) 904 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 904 may be augmented with or replaced by other processing units, such as GPU(s) 905. The GPU(s) 905 may include processing units specialized for but not necessarily limited to highly parallel computations, such as graphics and other visualization-related processing.

A chipset 906 may provide an interface between the CPU(s) 904 and the remainder of the components and devices on the baseboard. The chipset 906 may provide an interface to a random access memory (RAM) 908 used as the main memory in the computing device 900. The chipset 906 may provide an interface to a computer-readable storage medium, such as a read-only memory (ROM) 920 or non-volatile RAM (NVRAM) (not shown), for storing basic routines that may help to start up the computing device 900 and to transfer information between the various components and devices. ROM 920 or NVRAM may also store other software components necessary for the operation of the computing device 900 in accordance with the aspects described herein.

The computing device 900 may operate in a networked environment using logical connections to remote computing nodes and computer systems through local area network (LAN) 916. The chipset 906 may include functionality for providing network connectivity through a network interface controller (NIC) 922, such as a gigabit Ethernet adapter. A NIC 922 may be capable of connecting the computing device 900 to other computing nodes over a network 916. It should be appreciated that multiple NICs 922 may be present in the computing device 900, connecting the computing device to other types of networks and remote computer systems.

The computing device 900 may be connected to a mass storage device 928 that provides non-volatile storage for the computer. The mass storage device 928 may store system programs, application programs, other program modules, and data, which have been described in greater detail herein. The mass storage device 928 may be connected to the computing device 900 through a storage controller 924 connected to the chipset 906. The mass storage device 928 may consist of one or more physical storage units. A storage controller 924 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 900 may store data on a mass storage device 928 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 928 is characterized as primary or secondary storage and the like.

For example, the computing device 900 may store information to the mass storage device 928 by issuing instructions through a storage controller 924 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 900 may read information from the mass storage device 928 by detecting the physical states or characteristics of one or more particular locations within the physical storage units.

In addition to the mass storage device 928 described herein, the computing device 900 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 900.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 928 depicted in FIG. 9, may store an operating system utilized to control the operation of the computing device 900. The operating system may include a version of the LINUX operating system. The operating system may include a version of the WINDOWS SERVER operating system from the MICROSOFT Corporation. According to additional aspects, the operating system may include a version of the UNIX operating system. Various mobile phone operating systems, such as IOS and ANDROID, may also be utilized. It should be appreciated that other operating systems may also be utilized. The mass storage device 928 may store other system or application programs and data utilized by the computing device 900.

The mass storage device 928 or other computer-readable storage media may also be encoded with computer-executable instructions, which, when loaded into the computing device 900, transforms the computing device from a general-purpose computing system into a special-purpose computer capable of implementing the aspects described herein. These computer-executable instructions transform the computing device 900 by specifying how the CPU(s) 904 transition between states, as described herein. The computing device 900 may have access to computer-readable storage media storing computer-executable instructions, which, when executed by the computing device 900, may perform the methods described in relation to FIGS. 1-8.

A computing device, such as the computing device 900 depicted in FIG. 9, may also include an input/output controller 932 for receiving and processing input from a number of input devices, such as a keyboard, a mouse, a touchpad, a touch screen, an electronic stylus, or other type of input device. Similarly, an input/output controller 932 may provide output to a display, such as a computer monitor, a flat-panel display, a digital projector, a printer, a plotter, or other type of output device. It will be appreciated that the computing device 900 may not include all of the components shown in FIG. 9, may include other components that are not explicitly shown in FIG. 9, or may utilize an architecture completely different than that shown in FIG. 9.

As described herein, a computing device may be a physical computing device, such as the computing device 900 of FIG. 9. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes ¬ from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a referred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method, comprising:
accessing data that identifies a plurality of members;
generating, based on a first characteristic of the plurality of members, a first model that predicts a likelihood that the plurality of members is part of a first category of members;
determining that a confidence measure of the first model is below a threshold;
generating, based on a second characteristic of the plurality of members, at least a second model that predicts the likelihood that the one or more members is part of the first category of members;
determining that the confidence measure of the second model is above the threshold;
generating, based on the first characteristic of the plurality of members, a third model that predicts a likelihood that one or more of the members is part of a second category of members;
determining that a confidence measure of the third model is above a threshold;
generating a fourth model that is based on the second model and the third model; and
generating an output representative of the fourth model.

2. The method of claim 1, wherein the first category of members comprises one or more members of a population that perform a first action and the second category of members comprises one or more members of the population that perform a second action.

3. The method of claim 2, wherein the first action is purchase of a first product and the second action is purchase of a second product.

4. The method of claim 3, wherein the first product is a first type of checking account and the second product is a second type of checking account.

5. The method of claim 4, wherein the first type of checking account is a low balance checking account and the second type of checking account is a high balance checking account.

6. The method of claim 1, wherein the first characteristic of the plurality of members comprises one of an income level of the plurality of members, an education level of the plurality of members, or an initial account balance of the plurality of members.

7. The method of claim 1, wherein the fourth model predicts whether an individual is likely to perform a first action or a second action.

8. The method of claim 7, wherein the first action is the purchase of a first type of checking account the second action is the purchase of a second type of checking account.

9. A method, comprising:
accessing data that identifies a plurality of members;
determining a plurality of characteristics associated with the plurality of members;
comparing the plurality of characteristics to determine an impact of each of the plurality of characteristics on intra-level predictive performance;
generating, based on a first one of the characteristics, a first model that predicts a likelihood that the plurality of members is part of a first category of members;
determining that a confidence measure of the first model is below a threshold;
generating, based on a second one of the characteristics, at least a second model that predicts the likelihood that the one or more members is part of the first category of members;
determining that the confidence measure of the second model is above the threshold;
generating, based on the first one of the characteristics, a third model that predicts a likelihood that one or more of the members is part of a second category of members;
determining that a confidence measure of the third model is above a threshold;
generating a fourth model that is based on the second model and the third model; and
generating an output representative of the fourth model.

10. The method of claim 9, wherein the first category of members comprises one or more members of a population that perform a first action and the second category of members comprises one or more members of the population that perform a second action.

11. The method of claim 10, wherein the first action is purchase a first product and the second action is purchase of a second product.

12. The method of claim 11, wherein the first product is a first type of checking account and the second product is a second type of checking account.

13. The method of claim 12, wherein the first type of checking account is a low balance checking account and the second type of checking account is a high balance checking account.

14. The method of claim 9, wherein the first one of the characteristics comprises one of an income level of the plurality of members, an education level of the plurality of members, or an initial account balance of the plurality of members.

15. The method of claim 9, wherein the fourth model predicts whether an individual is likely to perform a first action or a second action.

16. The method of claim 15, wherein the first action is purchase of a first type of checking account and the second action is purchase of a second type of checking account.

17. An apparatus, comprising:
a processor; and
a memory, the memory storing instructions which, when executed by the processor, cause the apparatus to:
access data that identifies a plurality of members;
generate, based on a first characteristic of the plurality of members, a first model that predicts a likelihood that the plurality of members is part of a first category of members;
determine that a confidence measure of the first model is below a threshold;
generate, based on a second characteristic of the plurality of members, at least a second model that predicts the likelihood that the one or more members is part of the first category of members;
determine that the confidence measure of the second model is above the threshold;
generate, based on the first characteristic of the plurality of members, a third model that predicts a likelihood that one or more of the members is part of a second category of members;
determine that a confidence measure of the third model is above a threshold;
generate a fourth model that is based on the second model and the third model; and
generate an output representative of the fourth model.

18. The apparatus of claim 17, wherein the first category of members comprises one or more members of a population that perform a first action and the second category of members comprises one or more members of the population that perform a second action.

19. The apparatus of claim 18, wherein the first action is purchase of a first product and the second action is purchase of a second product.

20. The apparatus of claim 17, wherein the first characteristic of the plurality of members comprises one of an income level of the plurality of members, an education level of the plurality of members, or an initial account balance of the plurality of members.
